(19) United States
(12) Patent Application Publication
(10) Pub. No.: US 2003/0039763 A1
(43) Pub. Date: Feb. 27, 2003

(54) Methacrylate impregnated carbonaceous parts

(76) Inventors: Paul Po Hang Fong, Vancouver (CA); Michael P. Sexsmith, North Vancouver (CA); David Brown, Surrey (CA)

Correspondence Address: Robert W. Fieseler, McAndrews, Held & Malloy, Ltd., 34th Floor, 500 West Madison Street, Chicago, IL, 60661, US

(21) Appl. No.: 10/253,464

(22) Filed: Sep. 24, 2002

Related U.S. Application Data
(63) Continuation of application No. 09/896,178, filed on Jun. 29, 2001, now abandoned.
Application No. 09/896,178 is a division of application No. 09/286,144, filed on Apr. 5, 1999, now abandoned.

(51) Int. Cl. B05D 1/18

(52) U.S. Cl. 427/430.1

(57) ABSTRACT

Fragile, porous carbonaceous parts can be impregnated with a methacrylate polymer by curing the impregnated methacrylate in a curing atmosphere above atmospheric pressure. Preferably, the curing atmosphere is substantially free of oxygen. Thin carbonaceous components of flexible graphite for use in solid polymer fuel cells can be suitably impregnated in this way.

### CROSS-REFERENCE TO RELATED APPLICATION

This application is a division of U.S. patent application Ser. No. 09/286,144 filed Apr. 5, 1999, which is incorporated by reference herein in its entirety.

### FIELD OF THE INVENTION

The present invention relates to impregnation of porous carbonaceous parts with methacrylate based polymers. In particular, the present invention relates to impregnation of fragile porous carbonaceous parts for use in solid polymer fuel cells.

### BACKGROUND OF THE INVENTION

Porous parts, such as castings made from metal powders, are commonly impregnated with a suitable material in order to render them substantially fluid impermeable. Such parts may otherwise contain many microscopic pores that, even if not affecting structural strength, can cause leakage, affect machinability, or affect painting by trapping unwanted gases or liquids therein. Typically, impregnation is accomplished using a vacuum method. First, the porous part and a curable liquid impregnant are degassed in a chamber under vacuum. The part is immersed in the impregnant while still under vacuum (the part may be immersed before or after the degassing), and then the chamber is pressurized to drive the liquid impregnant into the evacuated pores of the part. Depending upon circumstances, atmospheric pressure may be sufficient for impregnating. However, it may be desirable to employ pressures above atmospheric during the impregnation step in some instances (for example, to accelerate impregnating or when using very viscous impregnants). The part is then typically washed in a suitable solvent to remove excess liquid impregnant from the surface of the part. Finally, the impregnant is cured thereby solidifying it and sealing the pores in the part.

Various polymerizable materials have been contemplated for use in impregnation applications. For sealing metal castings, methacrylate polymers are preferred impregnants. Before curing, methacrylate impregnants exhibit low viscosity facilitating impregnation. Any excess methacrylate is easily washed away with water. Methacrylates cure anaerobically by free radical polymerization and generally cure more rapidly at elevated temperature. To prevent curing (for example, for storage), the liquid methacrylate is kept at low temperature and is mildly aerated. Methacrylates are represented by the following general chemical formula:

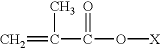

where X represents various other chemical groups (for example, X is a methyl group in methyl methacrylate). In commercial methacrylate impregnants, X is typically a hydrocarbon or a group consisting of carbon, hydrogen, and oxygen. Commercial methacrylate impregnants often comprise mixtures of various methacrylates and usually contain other compounds as additives. Generally, less than 20% by weight of a commercial impregnant is additive.

Notwithstanding that the curing of methacrylates is an anaerobic process, atmospheric air is generally employed as the pressurizing medium in industrial impregnation applications. As noted in the Loctite™ Worldwide Design Handbook, 1996/97, once the liquid methacrylate is impregnated into a porous part, the methacrylate no longer has a source of stabilizing air and curing begins. Curing is also promoted in the presence of certain metals (for example, copper) that may be a constituent in the parts themselves.

While impregnation is quite commonly used to fill and seal porous metal parts, impregnation techniques have also been employed to strengthen and/or seal porous carbonaceous parts. However, such parts tend to be substantially more fragile than powdered metal castings, and thus more care may be required during an impregnation process. Further, the preferred impregnants for metal castings may not be suitable for carbonaceous parts.

Typically, various components that are made predominantly of carbonaceous material are employed in solid polymer electrolyte fuel cell stacks. Carbonaceous components generally inexpensively provide the desired electrical conductivity and corrosion resistance. Depending on their construction however, these components may also contain significant undesirable porosity that might be suitably reduced via impregnation with a suitable polymerizable material.

Solid polymer electrolyte fuel cell stacks typically comprise numerous individual fuel cells that are stacked in series. The individual fuel cells employ a membrane electrode assembly (“MEA”) which comprises a solid polymer electrolyte or ion-exchange membrane disposed between two porous electrode layers, that is, an anode and a cathode layer. The electrodes, for instance, may comprise porous carbonaceous substrates. Adjacent electrodes in the stack are separated by fluid impermeable separator layers or plates, which may also be carbonaceous. Fuel and oxidant reactants are directed to the porous anode and cathode respectively. Flow field plates with reactant channels formed in one or both surfaces are frequently employed in the fuel cell constructions to direct these reactants in contact with the electrodes. The flow field plates may also be carbonaceous components and may be porous and fluid permeable or. non-porous and fluid impermeable. In the latter case, they may also serve as separator plates. In general, the stack components are made as thin as possible in order to increase volumetric energy density.

Flexible graphite is a porous carbonaceous sheet material that is prepared by compressing expanded (that is, exfoliated) graphite into sheets. Flexible graphite foils are suitable for use in certain solid polymer fuel cell -applications. As disclosed in U.S. Pat. No. 5,527,363, 1-2 mm thick flow field plates for fuel cells may be made in a simple manner by embossing Grafoil™ (an flexible graphite product of UCAR). However, unimpregnated Grafoil™ is relatively flexible, fragile, and porous. For fuel cell applications, it may be desirable to stiffen and strengthen such plates for ease of handling and improved resistance to compression. Further, it may be desirable to reduce the porosity. For instance, water trapped in the pores can freeze and damage a flexible graphite plate if the fuel cell is exposed to temperatures below freezing. Resins such as phenols, epoxies, melamines, and furans have been contemplated as impregnants for such thin, porous carbonaceous parts. For instance, in Japanese patent application publication number 60-065781, porous graphite plates for fuel cells were impregnated with phenol and furan impregnants to increase bending strength and to reduce air permeability. Toluene was used to rinse away excess impregnant before heat curing.

Although methacrylate polymers are common industrial impregnants and offer advantages over other known impregnants, it has proved difficult in some applications to achieve satisfactory results when impregnating methacrylates into certain porous carbonaceous parts (that is, at least those comprising predominantly carbon). In particular, it has proved difficult in applications involving relatively fragile parts made of flexible graphite. A problem is that, during curing, the part may sustain damage such as blisters (that is, where the skin of the part has been lifted, creating gas filled pockets on the surface) and thus the part is fragile with respect to impregnation.

It has now been discovered that subjecting the part to elevated pressure (that is, above atmospheric) during curing can prevent such damage. Thus, an undamaged, impregnated carbonaceous part can be prepared that comprises a fragile porous carbonaceous part and cured methacrylate impregnant within its pores.

### SUMMARY OF THE INVENTION

A method of impregnating a fragile porous carbonaceous part with a methacrylate impregnant comprises curing the impregnant in the part in a h curing atmosphere at a pressure greater than atmospheric pressure. The pressure of the curing atmosphere is preferably greater than about 50 psig (344.7 kPa). The curing atmosphere is preferably substantially free of oxygen to reduce inhibition of the curing process. A preferred curing atmosphere, for example, may comprise nitrogen. The method is particularly suitable for impregnants comprising greater than 80% by weight methacrylates.

A preferred embodiment of the above impregnation method involves vacuum impregnation where, before curing the impregnant, the steps additionally include: degassing the part and the impregnant under vacuum, immersing the part in the impregnant, impregnating the part with the impregnant in an impregnating atmosphere, and washing the impregnated part in a compatible solvent such as water. To accelerate impregnation, the pressure of the impregnating atmosphere may be greater than atmospheric pressure.

The method is suitable for impregnating parts comprising flexible graphite in thicknesses less than about 2 mm thick and densities less than about 1.7 g/cm³. Such impregnated parts may be used as components in a fuel cell, such as, for example, flow field plates or separators.

### DETAILED DESCRIPTION OF PREFERRED EMBODIMENT(S)

Fragile, porous carbonaceous parts that have been impregnated with methacrylate resins tend to undergo damage (for example, distortion or blistering) during the curing step. This damage can be prevented by subjecting the impregnated part to gas pressures above atmospheric during curing. An oxygen-free pressurizing media is preferred since it may provide for shorter curing periods and for more tolerance with regards to the curing process parameters (for example, temperature and time).

The damage suffered by such fragile, porous carbonaceous parts may be a consequence of local heating originating from the exothermic curing of the methacrylate. (Local heating may be expected to exhibit negative feedback in that the local curing rate increases with temperature, thereby aggravating local heating.) Significantly reducing the cure rate (for example, by lowering the curing temperature) may be effective in reducing local heating, but such an approach would undesirably slow down the production rate of the parts. Subjecting the impregnated part to increased gas pressures however does not necessitate a reduction in cure rate.

Flexible graphite is an example of a relatively fragile, porous carbonaceous material that may suffer blistering damage when an impregnated methacrylate resin is cured within. Embossed flexible graphite parts may be desirable for use in fuel cell applications, particularly as flow field plates in solid polymer electrolyte fuel cells. A flow field plate can be formed by embossing a commercially available sheet of flexible graphite, typically a few millimeters thick, between plates or rollers thereby creating embossed flow field channels and/or other features. Even after compression to densities in a range from about 1.1 to 1.7 g/cm³, such plates still have significant porosity and may be softer and more flexible than desired. The mechanical properties of such embossed flow field plates are rendered more suitable by resin impregnation.

In a preferred methacrylate impregnation process, the porous carbonaceous parts are baked before impregnating to remove any trapped or adsorbed fluids from the pores within. Then, the parts and a suitable methacrylate resin are degassed under a rough vacuum (for example, circa 1 torr). The parts may be immersed in the resin and then degassed together (“wet vacuum”) in a single vacuum chamber, or the parts and the resin may instead be degassed separately (“dry vacuum”). In the case of the latter, after a degassing period, the resin is transferred over so as to immerse the parts, while still under vacuum. Thereafter, the chamber containing the parts is pressurized thereby facilitating impregnation of the parts with methacrylate resin. As methacrylates have relatively low viscosity, often atmospheric pressure is adequate to drive the resin into the pores in a reasonable time. However, elevated pressures may be employed if desired to accelerate the impregnation or to force impregnant into pores that are not easily penetrated. In order to avoid exposing the methacrylate to oxygen (that may later inhibit curing), an inert pressurizing gas such as nitrogen is preferably used.

Generally, it is undesirable to have residual cured resin left on the surface of the impregnated parts. In fuel cell components such as, for example, cured methacrylate surface deposits can be detrimental insofar as thickness tolerances are concerned, and such deposits can also interfere with electrical contact. Thus, excess methacrylate resin is usually washed off the parts in water or other suitable solvent following impregnation before curing. However, water washing also removes some impregnant from the pores near the surface of the part. Thus, extended washing periods may undesirably remove too much impregnant. The extent of the washing process is of particular importance with thin impregnated parts where the surface to volume ratio is relatively high.

After washing, the impregnated parts may be cured in a timely manner by elevating the temperature of the impregnant. To prevent damage during curing, the part is subjected to gas pressures above atmospheric. Batches of impregnated parts can be cured in this way using an autoclave. Again, since the presence of oxygen can inhibit curing, it is preferable to use an oxygen-free pressurizing gas, such as nitrogen.

In general, the greater the pressure of the curing atmosphere, the more effective is the method in preventing damage. Thus, higher curing temperatures may be employed and shorter curing times may be possible for greater curing atmosphere pressures. The actual selection of preferred process parameters is thus dependent to some extent on certain processing preferences. Further, it is expected that preferred process parameters will depend to some extent on choice of resin and on the specific parts to be impregnated.

In conventional industrial impregnation applications, the presence of oxygen in the impregnating and/or curing environment generally does not significantly affect the results obtained and is thus not a significant concern. However, the presence of oxygen nonetheless can inhibit the curing of impregnated methacrylate. The inhibition is more significant the longer the exposure to oxygen, the greater the oxygen pressure, the higher the surface area of the exposed methacrylate, and the thinner the impregnated part. Further, it is generally more difficult to cure methacrylate in carbonaceous parts than in metallic ones. In the case of certain fragile carbonaceous parts, it may prove difficult to effect a damage-free curing of the methacrylate when using air as the pressurized curing or impregnating atmospheres. The amount of oxygen dissolved in the impregnant increases with air pressure and exposure time. Yet this slows down the cure rate, thereby necessitating longer curing and hence exposure times. As a result of this inhibiting feedback, the range of acceptable process parameters when using oxygen-containing atmospheres may be undesirably narrow. For instance, it may be necessary to ramp up the processing temperature above a certain minimum rate in order to effect a cure, and below a certain maximum rate in order to prevent blistering. However, there may be little, if any, acceptable processing window between these minimum and maximum rates. Difficulties in processing can be further aggravated in a large batch operation where a temperature gradient might exist among numerous parts. In such a case, it may be difficult to set processing conditions that do not cure too rapidly (causing damage) or too slowly. Problems associated with oxygen inhibition are avoided by the use of an inert gas.

The following examples have been included to illustrate different embodiments and aspects of the invention but these should not be construed as limiting in any way.

### EXAMPLES

In the following examples, fuel cell flow field plates were prepared by embossing flexible graphite sheets and then impregnating them with methacrylate resin. The flexible graphite employed was Grafoil™ (product of UCAR) having a thickness of about 1.8 mm and an average porosity about 50%. A commercially available methacrylate resin, Hernon HPS991 (trademark), was used as the impregnant. The embossed sheets (about 25 cm×25 cm) were first baked to remove water at 175° C. for 2 hours. Impregnation was then accomplished by degassing the batch of sheets and methacrylate resin in separate vacuum chambers under rough vacuum for about 2 hours. The methacrylate was next transferred under vacuum so as to immerse the sheets and degassing then continued for another 10 minutes. The chamber was then pressurized with air for about 8 hours at 90 psig to impregnate the sheets. The methacrylate bath was then removed and excess methacrylate was allowed to drip off the sheets. The impregnated sheets were then briefly washed (about 5 minutes) by mechanical agitation in an ambient temperature water bath to remove residual methacrylate from the surface. Different curing procedures were then employed as described in the following.

A series of impregnated plates were pressure cured under nitrogen in an autoclave under a variety of temperatures, temperature ramp rates, and pressures. For each combination of parameters, five plates were cured and the results are summarized in Table 1 below. In all cases, the temperature was ramped up to the desired maximum cure temperature and then a cooling period (about half an hour) was initiated. Plates were subjected to a bend test to infer the extent of curing.

TABLE 1
Pressure cure under nitrogen

| | Maximum cure | Temperature | |
|---|---|---|---|
| Pressure | temperature | ramp rate | |
| (psig) | (° C.) | (° C./min) | Qualitative results |
| 20 | 125 | 2 | Fully cured, all |
| | | | plates blistered |
| 50 | 100 | 2 | Fully cured, no |
| | | | blistering |
| 50 | 125 | 2 | Fully cured, one |
| | | | plate blistered |
| 80 | 100 | 3 | Fully cured, no |
| | | | blistering |
| 80 | 125 | 2 | Fully cured, no |
| | | | blistering |
| 80 | 100 | 5 | Fully cured, no |
| | | | blistering |
| 80 | 125 | 5 | Fully cured, no |
| | | | blistering |

A scratch test performed on the plates also indicated a sufficient presence of impregnant in the surface of the plates, although plates cured at 100° C. showed a slightly lower surface hardness than plates cured at 125° C.

As illustrated in the results in Table 1, satisfactory impregnated plates were obtained using a pressurized nitrogen cure. Blistering was substantially prevented by employing suitably high nitrogen pressures.

Another series of impregnated plates were pressure cured in air in an autoclave under various combinations of temperature, ramp rate, soak time, and pressure. Maximum curing temperatures ranged as high as 125° C. and pressures as high as 100 psig. As a result of this testing, a preferred curing cycle was found to employ an air pressure of 100 psig, a curing temperature of 125° C., and a soak time at this temperature of about 3 hours. At lower pressures, blistering was not reliably prevented. At lower soak times, the curing was generally not adequate. Thus, a pressurized air cure may be employed, but a longer cycle time seemed necessary. In the previous examples, typically 85-90% of the available porosity in the plates was filled with impregnant.

Impregnated plates were also cured at ambient pressure using various curing temperature profiles. In all cases, the plates were unacceptable for use (either as a result of blistering or incomplete cure). Thus, acceptable parts were not obtained when curing was performed at atmospheric pressure.

Finally, a series of impregnated plates were cured via conventional hot water immersion at 92° C. for different time periods. Again, five plates were tested in each case. For hot water immersion times of 5 and 15 minutes, the plates were not fully cured. For 30 and 60 minute immersion times, the plates were adequately cured and no blistering occurred. However, the surface hardness of these plates was significantly lower than that of the plates cured under pressurized nitrogen thereby compromising the integrity of the embossed flow field channels. Thus, while immersion in hot water effected curing without blistering, the prolonged exposure to hot water solvent appeared to result in a substantial, undesirable leaching of impregnant from the surface of the part.

While particular elements, embodiments and applications of the present invention have been shown and described, it will be understood, of course, that the invention is not limited thereto since modifications may be made by those skilled in the art without departing from the and scope of the present disclosure, particularly in light of the foregoing teachings.

What is claimed is:

1. A method of impregnating a porous carbonaceous part with an impregnant comprising a methacrylate, the method comprising the step of curing the impregnant in the part in a curing atmosphere at a pressure greater than atmospheric pressure.

2. The method of claim 1 wherein the impregnant comprises greater than 80% by weight methacrylate.

3. The method of claim 1 wherein the pressure of the curing atmosphere is greater than about 50 psig.

4. The method of claim 1 wherein the curing atmosphere is substantially oxygen-free.

5. The method of claim 4 wherein the curing atmosphere comprises nitrogen.

6. The method of claim 1 wherein the part comprises flexible graphite.

7. The method of claim 1 wherein the part is less than about 2 mm thick.

8. The method of claim 1 wherein the density of the part is less than about 1.7 g/cm³.

9. The method of claim 1 further comprising the prior steps of:
degassing the part and the impregnant under vacuum;
immersing the part in the impregnant;
impregnating the part with the impregnant in an impregnating atmosphere; and
washing the impregnated part in a compatible solvent.

10. The method of claim 9 wherein the compatible solvent is water.

11. The method of claim 9 wherein the pressure of the impregnating atmosphere is greater than atmospheric pressure.

12. The method of claim 9 wherein the impregnating atmosphere is substantially oxygen-free.

13. The method of claim 12 wherein the impregnating atmosphere comprises nitrogen.

14. The method of claim 1 wherein the part is a fuel cell component.

15. The method of claim 14 wherein the fuel cell component is a flow field plate.
